(19) United States
(12) Patent Application Publication
(10) Pub. No.: US 2012/0153194 A1
(43) Pub. Date: Jun. 21, 2012

(54) VALVE

(75) Inventor: Johann Weiß, Wangen (DE)

(73) Assignee: SVM SCHULTZ VERWALTUNGS-GMBH & CO. KG, Memmingen (DE)

(21) Appl. No.: 13/331,162

(22) Filed: Dec. 20, 2011

(30) Foreign Application Priority Data
Dec. 21, 2010 (DE) 10 2010 055 308.5

(51) Int. Cl. F16K 31/12

(52) U.S. Cl. 251/28

(57) ABSTRACT

The invention refers to a valve comprising a main nozzle arranged between inlet and outlet, and a pilot nozzle. The main nozzle has a main nozzle fit. It is sealed by a sealing body. The pilot nozzle has a pilot nozzle fit that can be sealed by a pilot nozzle body. A movable operating element arranged in the valve serves for opening and closing the main and pilot nozzle. When the valve is opened, first of all, the already accelerated operating element lifts the pilot nozzle body from the pilot nozzle fit.

### BACKGROUND OF THE INVENTION

The invention refers to a valve, comprising a main nozzle arranged between the inlet and outlet, and a pilot nozzle, wherein the main nozzle has a main nozzle fit that can be sealed by a sealing body, and the pilot nozzle has a pilot nozzle fit that can be sealed by a pilot nozzle body, and a movable operating element arranged in the valve for opening and closing, respectively, of main and pilot nozzle.

The before described valves of this kind are employed, for example, for closing and opening containers with media under high pressure. The arrangement is such that the high pressure of the media impacts the sealing body, and the resulting pressure forces press the sealing body on the main nozzle fit of the main nozzle. The drive of the operating element therefore must overcome at least these holding forces in order to open the main nozzle without limiting the scope of the invention. A solenoid as drive for the operating element, for example, is provided thereto, wherein the operating element is configured, for example, as armature.

In order to provide high forces for opening the main nozzle, the drive has to be dimensioned accordingly large and powerful, which results in corresponding costs. Therefore it is already known in the art, to equip the valve with a pilot nozzle, that is also arranged between inlet and outlet in the valve. The pilot nozzle has in general a clearly smaller cross section of the line compared to the main nozzle, and serves in terms of a “controlled leakage” for reducing the pressure difference of the pressure between inlet and outlet in the case of opening to an extent, that the resulting holding power impacting the sealing body will also be reduced. As the cross section in the area of the pilot nozzle is clearly smaller than in the main nozzle, also the pressure forces at the pilot nozzle are accordingly smaller.

These configurations of a valve known in the art work reliably until a pressure range of 300 to 400 bar. When the pressure is higher, the pressure forces increase accordingly such that for corresponding applications larger dimensioned drives are required. This causes higher costs, but also a larger constructional volume compared to the drives.

### SHORT SUMMARY OF THE INVENTION

It is an object of the invention to avoid at least one of the before mentioned disadvantages.

In order to solve this problem the invention refers to a valve as described in the beginning, and suggests that the movable operating element acts for opening and closing, respectively, of main and pilot nozzle on the sealing body or the pilot nozzle body, wherein during opening the valve at first the already accelerated operating element lifts the pilot nozzle body from the pilot nozzle fit, and, while reducing the pressure difference between inlet and outlet, respectively, the operating element lifts the pressure body from the main fit.

In the known solutions of the state of the art the drive of the operating element acts immediately against the pressure forces impacting on the pilot nozzle body, and pushes it on the pilot nozzle fit. In this case a suitably high power through the drive of the operating element is necessary. The suggestion according to the invention solves these problems very skillfully by first accelerating the operating element via the drive. There is no immediate effect yet on the pilot sealing body for lifting it from the pilot nozzle fit. By using the kinetic energy of the already accelerated operating element, i.e. its swing, and additional generation at the operating element, (shortly) after the start of the motion of the operating element first the pilot nozzle body is lifted from the pilot nozzle fit. If the pilot nozzle is opened and acts as “controlled leakage”, a pre-flooding of the working line, that is the outlet in the valve, occurs, until the force acting on the operating element is sufficient to lift the pressure body from the main fit.

The essential advantage of the invention is the fact that neither the constructive size of the drive of the valve or the entire valve, on the one hand, nor the drive itself must be enlarged; or larger configurations have to be employed for that, which would cause accordingly higher costs. The skilled design in the valve has the consequence that with the valve according to the invention media flows with clearly larger pressures and can be regulated and controlled, respectively.

The valve according to the invention serves here, of course, for opening and closing, respectively, the valve channel provided between inlet and outlet, or the main and pilot nozzle. The corresponding position of the operating element causes opening or closing of the valve. The pilot nozzle is here located in the valve also between inlet and outlet.

Another embodiment of the invention provides that the pilot nozzle body is arranged movably in the operating element, in particular charged by a pilot spring. It is the function of the pilot nozzle body to open or to close the pilot nozzle. Typically, the materials of pilot nozzle fit and pilot nozzle body are paired, so that, on the one hand, a permanent and, on the other hand, a sealing interaction is guaranteed. Thus, the invention comprises, for example, suggestions where the pilot nozzle body consists of rather hard material, for example metal or the like. In the same way it is also possible, that the pilot nozzle body consists of an elastomer or another elastic material. The development according to the invention suggests that the pilot nozzle body, consisting preferably of in this case rather hard and stable material, is arranged movably in the operating element, in particular charged by a pilot spring. A rather hard pilot nozzle body then interacts, for example, with a pilot nozzle consisting of elastic material, without limiting the scope of the invention thereto. When the passages of the interacting surfaces are sufficiently exact, according to the invention, also similar material or materials with the same hardness can be employed for the nozzle or the nozzle body. The use of the pilot spring, suggested according to the invention, achieves that the pilot nozzle body is always pushed with a certain power to the pilot nozzle fit. Thus, the exact positioning of the operating element with regard to the pilot nozzle is not decisive anymore for the impermeability or the position of the pilot nozzle (opened or closed).

According to the invention, the pilot nozzle body can be configured very variably. For example, the pilot nozzle body can be configured as cylinder or disc. It is also possible, to configure the pilot nozzle body as conical body or ball, the pilot nozzle body being held preferably in a boring of the operating element. Skillfully, also the pilot spring weighs the pilot nozzle body down, so that it is convenient to provide a stopper or the like in the boring at the operating element, to achieve an appropriate support or guidance of the pilot nozzle body. It is suggested in particular to provide a caulking at the end of the boring, that can be manufactured and provided in a simple manner. Assembly is done in such a way, that, after a boring has been provided in the operating element, the pilot spring is inserted on the backside, and the pilot nozzle body is put on. This is shifted against the power of the pilot spring into the boring, so that then the free end of the boring has to be caulked in such a way that the end area bulges in the boring, and thus the pilot nozzle body is prevented from sliding out (independently from its actual geometric shape).

It is an advantage in this connection, that the invention suggests that the pilot nozzle body is configured as a separate component, separated from the operating element. In the state of the art the use of a pilot nozzle that is opened or closed by a suitable surface at the operating element is well known. With the inventive design of the valve with the pilot nozzle body being provided as separate component, which is arranged also movably relative to the operating element an additional function at the invention is generated, namely an uncoupling of the motion of the operating element (at least for a certain period of time) from the function of opening or closing the pilot nozzle.

A modification according to the invention provides that the pilot spring relaxes (at least partly) during the opening of the pilot nozzle. This relaxing of the pilot spring achieves, that the pilot nozzle body, on which the pilot spring acts, acts on the pilot nozzle body and pushes it on the pilot nozzle fit, even if the operating element moves already in the opposite direction.

This is, for example, an option how the operating element is accelerated, without opening already the main and pilot nozzle. Besides this modification, however, also other options are possible.

In the preferred configuration of the invention it is provided that between inlet and outlet a valve channel is provided, and the main nozzle or the pilot nozzle are arranged in the valve channel. The inlet ends in a valve housing where the main nozzle as well as the pilot nozzle join.

Alternatively to this it is provided in the modification according to the invention that between inlet and outlet a valve channel and, additionally, a valve subchannel are provided, and the main nozzle and the pilot nozzle are arranged in the valve subchannel. As the main media flow is controlled or regulated via the main nozzle, the pilot nozzle is arranged in a bypass or valve subchannel, as by this only pre-flooding of the outlet arranged behind the main nozzle in the direction of flowing has to be carried out, and due to the smaller cross sections the pressure forces to be overcome when the pilot nozzle is opened, are clearly smaller. Therefore, it is alternatively also convenient to provide a valve subchannel.

In another modification according to the invention it is provided that the valve subchannel is arranged at least partly in the operating element, for example as diagonal boring in the operating element. The invention is not restricted with regard to the arrangement of the valve subchannel. It is an advantage to arrange the valve subchannel in the moved operating element or in the rest of the valve casing. In particular, constructive space is saved when the valve subchannel is integrated in the operating element.

Furthermore, a development of the invention suggests that the sealing body carries the pilot fit, and the pilot nozzle penetrates the sealing body and leads to the main nozzle. This modification according to the invention combines several advantages. First of all, it is a very space-saving configuration, as the sealing body does not only serve for sealing the main nozzle fit, but additionally also carries the pilot nozzle fit. The sealing body has here a boring, channel, recess or the like, that penetrates it and leads to the main nozzle. Thus the sealing body itself also forms the pilot nozzle.

In the preferred alternative configuration of the invention the sealing body is made of an elastomer, thermoplast, metal or ceramics. In this configuration the sealing body is multi-functional. First of all, it interacts with the main nozzle fit. The main nozzle is made of harder material, for example metal, compared to the sealing body. At the same time, the sealing body itself forms the pilot nozzle fit. Here, soft material of the pilot nozzle fit interacts with the pilot nozzle body, that is, if necessary, also made of metal. The sealing body takes over the sealing also in the nozzle function.

The invention provides very different materials for the sealing body. The sealing body may consist of rather hard materials, such as, for example, metal or ceramics, or of rather soft materials such as elastomers, thermoplast or other synthetic materials. Thus it is possible to configure the valve according to the invention in a very variable way. Depending on the type of the main nozzle it is possible, to adapt the pairing of the materials of sealing body and pilot nozzle body. If the main nozzle is of hard material, the sealing body is preferably made of soft material and the pilot nozzle body of hard material. If the main nozzle is made of soft material, the sealing body is preferably made of hard and the pilot nozzle body of soft material.

Of course, this double function, provided by the sealing body, has corresponding advantages in view of the costs, as the otherwise necessary single components are avoided.

Furthermore, the modification according to the invention provides, that the sealing body is supported movably in the front end of the operating element, in particular parallel to the direction of movement of the operating element. Preferably here the sealing body is arranged in a recess, the depth of which being somewhat larger than the thickness of the sealing body (if seen parallel to the moving direction of the sealing body), so that the sealing body is supported somewhat movably in the operating element. What is essential here is that in this configuration of the invention the outer surface of the sealing body does not take over a sealing function, but the surfaces orientated angled, in particular rectangular, to the motion direction of the operating element, the surfaces acting, on the one hand, as sealing body, on the other hand, as pilot nozzle fit. This constructive solution is favorable as thus the durability of the sealing body is guaranteed, as the surfaces do not move and wear parallel to the motion direction of the operating element at a surface, that is rather stationary compared with it.

The sealing body itself is developed advantageously in a development according to the invention, that, if necessary, can also be claimed protection for independently and separated from the main idea of this invention, if necessary in a divisional application. First of all, the sealing body is supported in the operating element in such a way that this centers itself with reference to the main nozzle fit. The misalignments are compensated by the suggestion according to the invention, and thus the risk of leakage reduces clearly. This makes it possible to employ the valve according to the invention or even the particular configuration of the sealing body in very high pressure ranges of media flows to be controlled and regulated, respectively.

Furthermore, the invention suggests in particular in a modification that the sealing body is configured, for example, conically or at least hemispheric, at least in the area interacting with the main nozzle fit. The result is thus not only a sealing edge at the main nozzle fit, but a rather wide sealing surface, and thus also, at the same time, with the sealing body being also movable parallel to the surface of the main nozzle fit, a sealing of the main fit that is considerably less prone to wear.

The valve according to the invention is used preferably for regulating and controlling of media flows, in particular gas, (alternatively also liquid) or cold, or supercooled media under high pressure, of preferably more than 500 bar, in particular of more than 600 bar, or of even more than 750 bar. Just for these rather high pressures, according to the invention, valves, that are constructed considerably larger, in particular drives of the operating element are required, considerably increasing the costs of such valves, and this is avoided by the suggestion according to the invention. The suggestion according to the invention makes the employment of the structurally identical valve in a higher pressure range possible with low constructive effort.

Another modification according to the invention provides an armature of a solenoid as an operating element, and the magnetic field generated by a coil flown through by current moves or accelerates the armature. In this modification according to the invention a solenoid is suggested as drive for the operating element. The magnetic field generated by the coil flown through by electricity acts on the armature or the operating element. However, this is not the only modification for providing the operating element, for example also modifications according to the electromotor principle or according to the linear motor principle can be employed analogously.

### SHORT DESCRIPTION OF THE DIFFERENT VIEWS OF THE DRAWINGS

In the drawing the invention is shown schematically in particular in an embodiment. In the figures:

FIG. 1 depicts in a side view a valve according to the invention

FIGS. 2a, b, c, d depict in an enlarged detailed view according to FIG. 1 different positions during the opening process of the valve according to the invention.

In the figures identical or corresponding elements each are indicated with the same reference numbers, and therefore are, if not useful, not described anew.

### DETAILED DESCRIPTION OF THE PREFERRED EMBODIMENTS

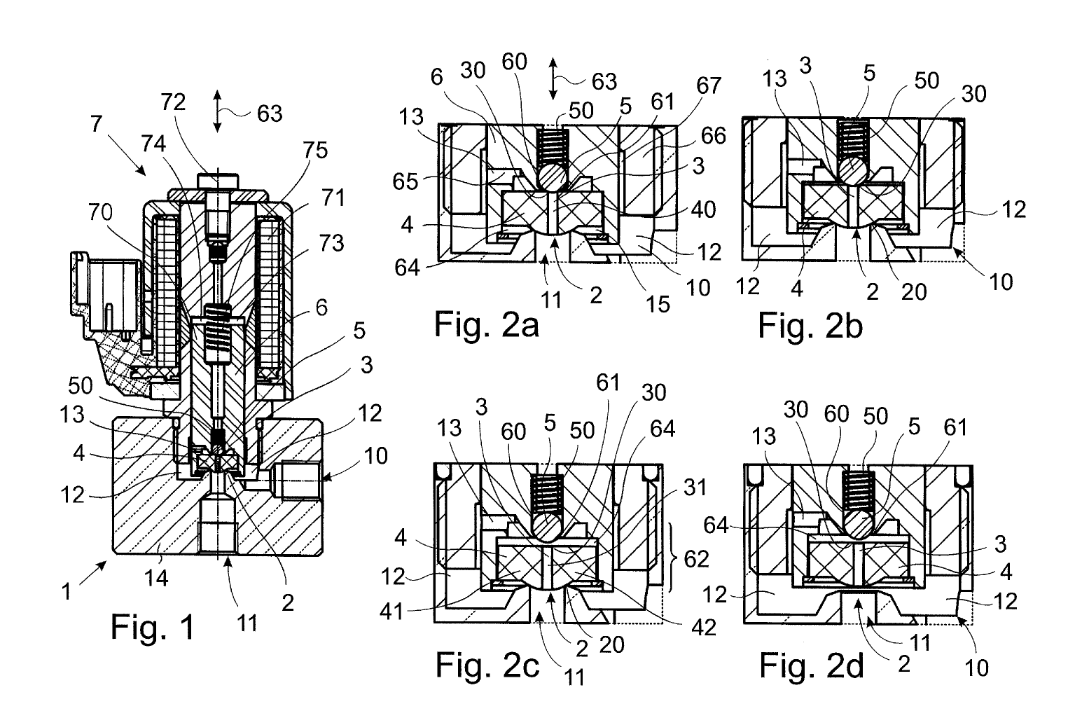

FIG. 1 shows the valve according to the invention together with a solenoid 7 serving here, for example, as drive for the operating element 6.

The solenoid 7 in general has a coil 71 carrying a multitude of wire windings. If current flows through the wire wound on the coil 71, a magnetic field is generated that is in the interior of the coil 71 essentially parallel to the axis 72 of the coil. The coil 71 surrounds at least partly an armature space 73, where the armature 70 is supported longitudinally moving parallel to the coil axis 72. In the example shown here the armature 70 is the operating element 6.

The operating element 6 extends in the valve block 14 of the valve 1. In the valve 1, in particular in the valve block 14, also an inlet 10 as well as an outlet 11 are arranged rectangular to each other. The inlet 10 and the outlet 11 are connected to each other via a valve channel 12, the valve housing 15 is part of the valve channel 12. In the valve housing 15 at least the main nozzle 2 is arranged that is sealed through the sealing body 4. The sealing body 4 is put or pushed on or lifted off the main nozzle fit 20 of the main nozzle 2 by the operating element 6. The configuration, shown in FIG. 1, of the valve 1 according to the invention and of the solenoid 7 connected with it, is here chosen in such a way that the armature 70/operating element 6 is lifted upwards, when electrified, and closes the air gap 74 of the armature space 73. This motion is here carried out against the restoring force of the armature spring 75. In not-electrified condition therefore the armature spring 75 pushes the armature 70/operating element 6 downwards such that the sealing body 4 held at the front end 62 in the operating element 6 pushes on the main nozzle fit 20 of the main nozzle 2.

The principle of the invention shown here (to which the invention is not restricted) has, besides the main nozzle 2, also a pilot nozzle 3. The pilot nozzle 3 is also arranged between inlet 10 and outlet 11. It is here provided in a valve subchannel 13, the valve subchannel 13 leads to the valve housing 15 or is in communicating connection with the valve channel 12.

This can be seen in more detail, for example in FIG. 2a.

FIG. 2a shows the closed position of the valve 1. The connected pressure acts via the inlet 10, the valve channel 12 and the valve housing 15, and pushes it additional to the force of the armature spring 75 on the main nozzle fit 20 of the main nozzle 2.

The arrangement is chosen in a way that the sealing body 4 does not only serve for sealing the main nozzle fit 20 or the main nozzle 2, but also forms the pilot nozzle 3, itself. For that purpose the sealing body 4 is penetrated completely by an opening or boring 40, the boring 40 leading to the main nozzle 2 on the side facing the outlet 11.

The pilot nozzle 3 is closed by the pilot nozzle body 5 that is pushed on the pilot nozzle fit 30. A pilot spring pressing on the pilot nozzle body 5 takes care of that. The arrangement is here chosen in such a way that the pilot nozzle body 5 is located in the front end of the operating element 6.

The configuration of the operating element 6 is here chosen in such a way that the area of the operating element 6 extending in the valve housing 15 in the front end 62, first of all, receives the sealing body 4 in a recess 64. The direction of movement of the operating element 6 is shown in FIG. 1 and FIG. 2a, respectively, by arrow 61. With reference to the front end of the operating element 6 the pilot nozzle body 5 is arranged in a boring 60 behind the sealing body 4. The diameter of the boring 60 is here clearly smaller than the diameter of the recess 64 receiving the sealing body 4. The boring 60 as well as the recess 64 are coaxial to the coil axis 72.

The depth of the recess 64 in the motion direction 63 (direction of the coil axis 72) is here larger than the thickness of the sealing body 4. Thus, the sealing body 4 does not fill the recess 64 completely. Furthermore, in the operating element 6 a radial extending (with reference to the coil axis 72) diagonal boring 65 is located that acts as valve subchannel 13, and connects the recess 64 with the valve housing 15 and thus also the inlet 10. For that the guide 66 of the operating element has in the bottom area a widening 67 by which the valve housing 15 is connected with the valve subchannel 13. Guiding is carried out above the widening where the diameter tapers.

The arrangement is now chosen in such a way that the pilot nozzle body 5 is supported in the boring 60 of the operating element 6, and basically also carries out the motion of the operating element 6, however, the pilot spring 50 presses the pilot nozzle body 5 downwards in such a way that the pilot nozzle body 5 seals the pilot nozzle 3. In order to prevent the pilot nozzle body 5 from dropping of the boring 60, at the boring 60 or the recess at the bottom edge a caulking is provided serving as stopper for the pilot nozzle body 5. The caulking is geometrically chosen in such a way that the ball, the pilot nozzle body 5 consists of, projects still at least partly over the edge of the caulking downward, and thus is able to act on the pilot nozzle fit 30. The pressure prevailing at the side of the entrance is connected via the inlet 10, the valve channel 12, the valve housing 15 and the valve subchannel 13 also to the recess 64 at the pilot nozzle 3. The sealing body 4 acts here not only as pilot nozzle 3, but also at the same time as sealing body 4 for the main nozzle 2. The gist of the invention is now to have recognized that the dynamic of the motion of the operating element 6 or the armature 70 is used for opening the pilot nozzle 3. This may be gathered from FIG. 2b. This shows the situation where the coil 71 is excited, and the armature 70 or the operating element 6 is shifted upwards by a certain length of path. The operating element 6 is here accelerated by the excited coil 71 in the pressure-compensated space of the valve housing 15. It is essential here, that this upwards motion of the operating element 6 has not yet lead to an opening of neither the pilot nozzle 3 nor the main nozzle 2. The sealing body 4 remains seated densely on the main nozzle fit 20 of the main nozzle 2, the pilot nozzle body 5 still sits densely, supported by the pilot spring 50 on the pilot nozzle fit 30 of the pilot nozzle 3.

In the example shown here the operating element 6 is accelerated on a path of a few tenth of millimeters until about 1.5 mm or more, depending on the configuration. This “swing” or kinetic energy of the operating element 6 is used for lifting the pilot nozzle body 5 from the pilot nozzle fit 30, namely when the caulking 61 is in contact with the pilot nozzle body 5. The pilot spring 50 then has relaxed slightly here. This situation is shown in FIG. 2c, where the sealing body 4 still sits densely on the main nozzle fit 20 of the main nozzle 2, however, the “purposeful leakage” via the pilot nozzle 3 exists.

A pre-flooding of the working line or outlet 11 takes place via the valve subchannel 13, the recess 64 and the penetration 31 arranged in the sealing body 4 as pilot nozzle 3. The high difference between the inlet 10 and the outlet 11 at the beginning is lowered until the magnetic force is sufficient, and the pressure forces, that hold the sealing body 4 on the main nozzle fit 20, lift it, and thus also open the main nozzle 2. FIG. 2d shows this situation. The invention comprises here also the essential aspect that the pilot nozzle 3 moves together with the operating element 6. In the shown embodiment it is not realized as static nozzle, but as dynamic nozzle.

In connection with FIG. 2 the following essential other aspect of the invention has to be pointed out: The sealing body 4 does not only have a certain axial motion (parallel to the coil axis 72), but also a certain radial motion (also with reference to the coil axis 72). This leads to a self adjusting effect of the sealing body 4 on the main nozzle fit 20. It has to be taken into consideration here that the sealing body 4 according to the modification shown, for example, in FIG. 2c is not configured as simple cylinder, but at a cylindrical or disc-like basic body 41 on the side facing the main nozzle 2 a cone-like, conical, hemispheric or ball segment-like part body 42 is attached in the middle. By a certain radial motion of the sealing body 4 in the recess 64 the sealing body 4 is always positioned perfectly on the main nozzle fit 20, while misalignments are avoided and thus leakage is reduced.

Although the invention has been described by means of exact embodiments that are explained in the very detail, it is pointed out that this serves only for illustration, and that the invention is not necessarily restricted to it, as alternative embodiments and methods will become clear for experts in view of the disclosure. Accordingly, changes are considered that can be made without deviating from the contents of the described invention.

1. Valve, consisting of a main nozzle arranged between an inlet and an outlet, and a pilot nozzle, with the main nozzle having a main nozzle fit sealable by a sealing body, and the pilot nozzle having a pilot nozzle fit that sealable by a pilot nozzle body, and a movable operating element arranged in the valve acting for opening or closing the main and pilot nozzle on the sealing body or the pilot nozzle body, wherein while opening the valve, the already accelerated operating element first lifts the pilot nozzle body from the pilot nozzle fit, and, after reduction of the pressure difference between the pressure in the inlet and outlet, respectively the operating element lifts the sealing body from the main nozzle fit.

2. Valve according to claim 1, wherein a pilot spring is provided, and the operating element has a boring or recess with an end, and wherein the pilot nozzle body is arranged movably in the operating element, in particular charged by the pilot spring, and/or wherein the pilot nozzle body is configured as conical body or as ball, and is held in the boring or recess of the operating element, in particular by caulking the end of the boring or recess, and/or wherein the pilot nozzle body is configured as separate component, separated from the operating element.

3. Valve according to claim 1, wherein between the inlet and the outlet a valve channel is provided, and the main and the pilot nozzle, respectively, are arranged in the valve channel.

4. Valve according to claim 1, wherein between inlet and outlet a valve channel and a valve subchannel are provided, and the main nozzle is arranged in the valve channel, and the pilot nozzle is arranged in the valve subchannel.

5. Valve according to claim 1, wherein between inlet and outlet a valve channel and a valve subchannel are provided, and with the valve subchannel being arranged, at least partly, in the operating element, for example as boring or diagonal boring in the operating element, and/or with the pilot spring relaxing, when the pilot nozzle opens.

6. Valve according to claim 1, wherein the operating element has a front recess, and wherein the sealing body carries the pilot nozzle fit, and the pilot nozzle penetrates the sealing body and leads to the main nozzle, and/or wherein the sealing body is supported in the front end of the operating element movably, in particular parallel to the direction of movement of the operating element, and/or wherein the sealing body consists of an elastomer, thermoplast, metal or ceramics, and/or wherein the sealing body is arranged and held movably in the front recess of the operating element, and the valve subchannel flows in the recess behind the sealing body.

7. Valve according to claim 1, wherein a pilot nozzle is provided, and wherein the pilot nozzle is arranged at the operating element and moves together with it.

8. Valve according to claim 1, wherein a sealing body is provided centering relative to the main nozzle fit is provided.

9. Valve according to claim 1, wherein a conical or at least hemispherical design of the region of the sealing body interacting with the main nozzle fit is provided.

10. Valve according to claim 1, wherein as operating element an armature of a solenoid and a magnetic field generated by a coil flown through by electricity is provided, and wherein the valve serves for controlling and regulating media flows, in particular gas or cold and supercooled media under high pressure, preferably of more than 500 bar, in particular more than 600 bar or more than 750 bar, and/or the magnetic field generated by the coil flown through by electricity moves and accelerates the armature, respectively.
